(19) United States
(12) Patent Application Publication
(10) Pub. No.: US 2016/0092182 A1
(43) Pub. Date: Mar. 31, 2016

(54) METHODS AND SYSTEMS FOR OPTIMIZING EXECUTION OF A PROGRAM IN A PARALLEL PROCESSING ENVIRONMENT

(71) Applicant: Cognitive Electronics, Inc., Boston, MA (US)

(72) Inventor: Andrew C. Felch, Palo Alto, CA (US)

(73) Assignee: Cognitive Electronics, Inc., Boston, MA (US)

(21) Appl. No.: 14/704,624

(22) Filed: May 5, 2015

Related U.S. Application Data
(63) Continuation of application No. 13/594,125, filed on Aug. 24, 2012, now abandoned.
(60) Provisional application No. 61/528,069, filed on Aug. 26, 2011.

(51) Int. Cl. G06F 9/45

(52) U.S. Cl. CPC G06F 8/4434; G06F 8/48

(57) ABSTRACT

An automated method of optimizing execution of a program in a parallel processing environment is described. The program is adapted to execute in data memory and instruction memory. An optimizer receives the program to be optimized. The optimizer instructs the program to be compiled and executed. The optimizer observes execution of the program and identifies a subset of instructions that execute most often. The optimizer also identifies groups of instructions associated with the subset of instructions that execute most often. The identified groups of instructions include the identified subset of instructions that execute most often. The optimizer recompiles the program and stores the identified groups of instructions in instruction memory. The remaining instructions portions of the program are stored in the data memory. The instruction memory has a higher access rate and smaller capacity than the data memory. Once recompiled, subsequent execution of the program occurs using the recompiled program.

### CROSS-REFERENCE TO RELATED APPLICATIONS

This application is a continuation application of U.S. patent application Ser. No. 13/594,125, filed on Aug. 24, 2012, which claims priority to U.S. Provisional Patent Application No. 61/528,069 filed Aug. 26, 2011, which applications are hereby incorporated by reference to the maximum extent allowable by law.

### BACKGROUND OF THE INVENTION

Within the last few years, the emphasis in computer architecture design has shifted from improving performance to lowering power consumption. Computer systems in the mobile computing, supercomputing, and cloud computing fields can easily escape the total amount of available power. Thus, greater power efficiency (performance per watt) is required in order to reach higher levels of performance. Computer architectures designed for power efficiency in different ways typically share quite similar constituent mechanisms known to be power efficient.

One such constituent mechanism of power efficient computer architectures is small instruction memory storage. Instruction memory is memory used specifically for instruction storage that provides high performance access to the instructions for execution within an instruction cycle. In modern computer architectures, the instruction cycle is frequently pipelined. The instruction cycle is responsible for completion of each instruction by carrying out a process which includes a first step of fetching the instruction data for the current instruction. No other operations for the instruction can proceed until the instruction data has been fetched. Therefore, it is important for improved performance that the instructions can be retrieved from instruction memory quickly. It is also important in power efficient systems that the instruction memory run power efficiently. However, as the size of the instruction memory increases, both the power consumption and latency of fetching increases. This results both in increasing power consumption and decreasing performance of the overall computer architecture.

Most modern architectures today use a special instruction memory (“i-cache”) that is dedicated to the purpose of serving these instructions quickly. The instruction memory is generally smaller than the total size of the program being executed. Therefore, the instruction memory usually cannot hold all of a program's instructions. In order to compensate for the small size of the instruction memory, power-efficient architectures include a cache memory that stores some of the program's instructions. The cache memory is a special instruction-memory mechanism that consumes substantial power. Various algorithms are known in the art for replacing instructions between the instruction cache and memory to reduce the number of cache misses. However, use of caching mechanisms is undesirable as it increases the total power requirements of the computer architecture.

In power efficient architectures, the instruction memory is preferably not implemented as a cache because the overhead of the cache includes a “content-addressable memory” system. The content-addressable memory has considerable hardware and power requirements. Furthermore, power efficient systems often implement multiple threads per core, and it is possible that the predicting and replacement procedures of instructions in the instruction cache do not serve these multiple threads properly.

Therefore, it is desirable to improve power efficiency of such architectures by optimizing the storage of program instructions between an instruction memory and a data memory.

### BRIEF SUMMARY OF THE INVENTION

In one embodiment, an automated method of optimizing execution of a program in a parallel processing environment is described. The program is adapted to execute in data memory and instruction memory. An optimizer receives the program to be optimized. The optimizer instructs the program to be compiled and executed. The optimizer observes execution of the program and identifies a subset of instructions that execute most often. The optimizer also identifies groups of instructions associated with the subset of instructions that execute most often. The identified groups of instructions include the identified subset of instructions that execute most often. The optimizer recompiles the program and stores the identified groups of instructions in instruction memory. The remaining instructions portions of the program are stored in the data memory. The instruction memory has a higher access rate and smaller capacity than the data memory. Once recompiled, subsequent execution of the program occurs using the recompiled program.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a flowchart diagram illustrating a first computer program comprising a single thread in accordance with one preferred embodiment of this invention;

FIG. 2 is an illustration showing assembly code for the first computer program of FIG. 1 in accordance with one preferred embodiment of this invention;

FIG. 3 is an illustration showing the assembly code of FIG. 2 supplemented with logging instructions of a first type in accordance with one preferred embodiment of this invention;

FIG. 4 is a flowchart diagram illustrating steps for tracing a computer program having logging instructions in accordance with one preferred embodiment of this invention;

FIG. 5 is a table demonstrating the logged executions of the instructions of the assembly code of FIG. 2 in accordance with one preferred embodiment of this invention;

FIG. 6 is a table showing the total fetch cost of a first memory layout of the assembly code of FIG. 2 in accordance with one preferred embodiment of this invention;

FIG. 7 is a table showing the total fetch cost of a second memory layout of the assembly code of FIG. 2 in accordance with one preferred embodiment of this invention;

FIG. 8 is a flowchart diagram illustrating a second computer program comprising a plurality of threads in accordance with one preferred embodiment of this invention;

FIG. 9 is an illustration showing assembly code of the second computer program of FIG. 8 in accordance with one preferred embodiment of this invention;

FIG. 10 is an illustration showing the assembly code of FIG. 9 supplemented with logging instructions of the first type in accordance with one preferred embodiment of this invention;

FIG. 11 is a log of execution of the threads of the second computer program of FIG. 8 in accordance with one preferred embodiment of this invention;

FIG. 12 is a table showing the total fetch cost of a first memory layout of the second computer program of FIG. 1 in accordance with one preferred embodiment of this invention;

FIG. 13 is a flowchart illustrating steps for tracing a computer program having logging instructions in accordance with one preferred embodiment of this invention;

FIG. 14 is an illustration showing the assembly code of FIG. 10 supplemented with logging instructions of a second and third type in accordance with one preferred embodiment of this invention;

FIG. 15 is a table of log entries of a trace of the assembly code of FIG. 14 in accordance with one preferred embodiment of this invention;

FIG. 16 is a table illustrating the log entries of FIG. 15 processed into instruction counts of the instructions of the assembly code of FIG. 14 in accordance with one preferred embodiment of this invention;

FIG. 17 shows a total fetch cost of a first layout of the assembly code of FIG. 9 and the total fetch cost of a reorganized layout of the assembly code of FIG. 9 based on the instruction counts of FIG. 16 in accordance with one preferred embodiment of this invention;

FIG. 18 is an illustration of a technique for optimizing and reorganizing a computer program between an instruction memory and a data memory in accordance with one preferred embodiment of this invention;

FIG. 19 is an overview of a parallel computing architecture for implementing the optimization technique of FIG. 18;

FIG. 20 is an illustration of a program counter selector for use with the parallel computing architecture of FIG. 21;

FIG. 21 is a block diagram 2200 showing an example state of the architecture 2160 in FIG. 19;

FIG. 22 is a block diagram illustrating cycles of operation during which eight Virtual Processors execute the same program but starting at different points of execution; and

FIG. 23 is a block diagram of a multi-core system-on-chip

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Referring to the drawings in detail, wherein like reference numerals indicate like elements throughout, power efficient systems implementing instruction memories lacking the content-addressable nature of caches are presented. These instruction memories are typically much smaller than the entire size of the program being executed. Therefore, some instructions that do not fit in the instruction memory are stored in the data memory. Preferably, most instruction fetches are able to be served by the dedicated instruction memory and therefore, the data memory is only accessed for portions of the program that are not performance-critical. In order to ensure that most instruction fetches are able to be served by the dedicated instruction memory, the code layout of a program is optimized so that the instructions that occur in performance-critical sections of a program are fetched more frequently from the instruction memories. This optimization allows multithreaded processing cores with reduced instruction memory resources to perform as though they had larger instruction memories. Techniques for identifying and storing performance-critical portions of the program in the instruction memory are presented.

The performance critical portions are identified by performing analysis of the program before, during, and after its execution in an iterative process that gradually improves the layout of the program. The iterative process results in the performance-critical portions being placed in the instruction memory during initialization or being swapped into the instruction memory during runtime without the need for hardware caching.

Parallel Computing Architecture

The optimization techniques will be better understood in view of the low-power parallel computing architecture presented below. The parallel computing architecture comprises a plurality of separate thread hardware (e.g., virtual processors or the like), executing a respective plurality of independent threads. The plurality of virtual processors share a non-caching instruction memory. The following parallel computing architecture is one example of an architecture that may be used to implement the features of this invention. The architecture is further described in U.S. Patent Application Publication No. 2009/0083263 (Felch et al.), which is incorporated by reference herein.

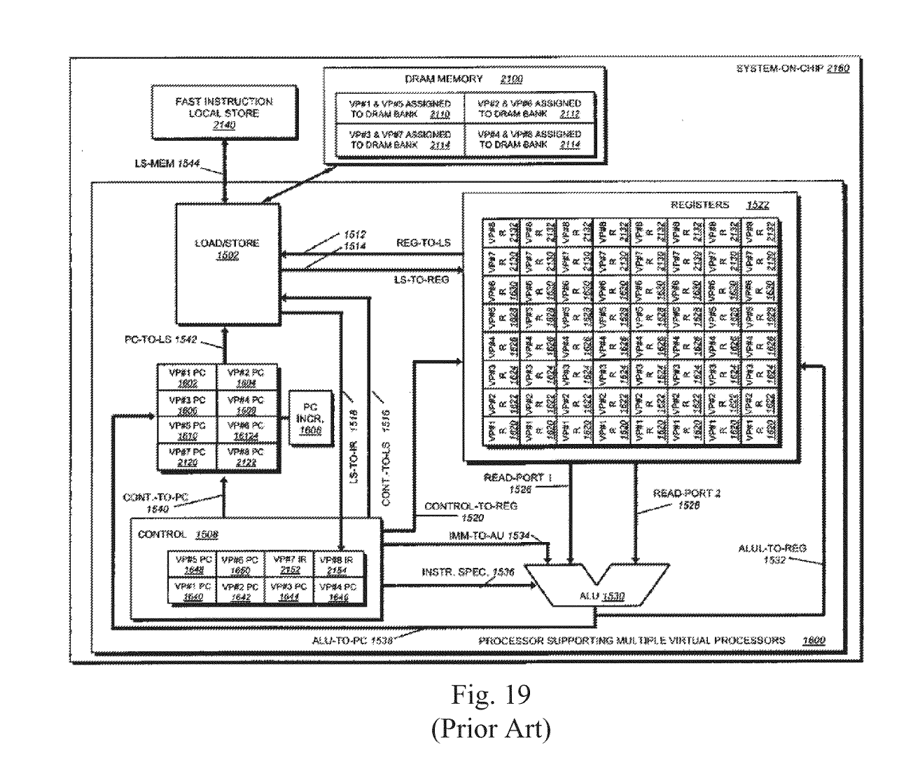

FIG. 19 is a block diagram schematic of a processor architecture 2160 utilizing on-chip DRAM 2100 memory storage as the primary data storage mechanism and Fast Instruction Local Store, or just Instruction Store, 2140 as the primary memory from which instructions are fetched. The Instruction Store 2140 is fast and is preferably implemented using SRAM memory. In order for the Instruction Store 2140 to not consume too much power relative to the microprocessor and DRAM memory, the Instruction Store 2140 can be made very small. Instructions that do not fit in the SRAM are stored in and fetched from the DRAM memory 2100. Since instruction fetches from DRAM memory are significantly slower than from SRAM memory, it is preferable to store performance-critical code of a program in SRAM. Performance-critical code is usually a small set of instructions that are repeated many times during execution of the program.

The DRAM memory 2100 is organized into four banks 2110, 2112, 2114 and 2116, and requires 4 processor cycles to complete, called a 4-cycle latency. In order to allow such instructions to execute during a single Execute stage of the Instruction, eight virtual processors are provided, including new VP#7 (2120) and VP#8 (2122). Thus, the DRAM memories 2100 are able to perform two memory operations for every Virtual Processor cycle by assigning the tasks of two processors (for example VP#1 and VP#5 to bank 2110). By elongating the Execute stage to 4 cycles, and maintaining single-cycle stages for the other 4 stages comprising: Instruction Fetch, Decode and Dispatch, Write Results, and Increment PC; it is possible for each virtual processor to complete an entire instruction cycle during each virtual processor cycle. For example, at hardware processor cycle T=1 Virtual Processor #1 (VP#1) might be at the Fetch instruction cycle. Thus, at T=2 Virtual Processor #1 (VP#1) will perform a Decode & Dispatch stage. At T=3 the Virtual Processor will begin the Execute stage of the instruction cycle, which will take 4 hardware cycles (half a Virtual Processor cycle since there are 8 Virtual Processors) regardless of whether the instruction is a memory operation or an ALU 1530 function. If the instruction is an ALU instruction, the Virtual Processor might spend cycles 4, 5, and 6 simply waiting. It is noteworthy that although the Virtual Processor is waiting, the ALU is still servicing a different Virtual Processor (processing any non-memory instructions) every hardware cycle and is preferably not idling. The same is true for the rest of the processor except the additional registers consumed by the waiting Virtual Processor, which are in fact idling. Although this architecture may seem slow at first glance, the hardware is being fully utilized at the expense of additional hardware registers required by the Virtual Processors. By minimizing the number of registers required for each Virtual Processor, the overhead of these registers can be reduced. Although a reduction in usable registers could drastically reduce the performance of an architecture, the high bandwidth availability of the DRAM memory reduces the penalty paid to move data between the small number of registers and the DRAM memory.

This architecture 1600 implements separate instruction cycles for each virtual processor in a staggered fashion such that at any given moment exactly one VP is performing Instruction Fetch, one VP is Decoding Instruction, one VP is Dispatching Register Operands, one VP is Executing Instruction, and one VP is Writing Results. Each VP is performing a step in the Instruction Cycle that no other VP is doing. The entire processor's 1600 resources are utilized every cycle. Compared to the naive processor 1500 this new processor could execute instructions six times faster.

As an example processor cycle, suppose that VP#6 is currently fetching an instruction using VP#6 PC 1612 to designate which instruction to fetch, which will be stored in VP#6 Instruction Register 1650. This means that VP#5 is Incrementing VP#5 PC 1610, VP#4 is Decoding an instruction in VP#4 Instruction Register 1646 that was fetched two cycles earlier. VP#3 is Dispatching Register Operands. These register operands are only selected from VP#3 Registers 1624. VP#2 is Executing the instruction using VP#2 Register 1622 operands that were dispatched during the previous cycle. VP#1 is Writing Results to either VP#1 PC 1602 or a VP#1 Register 1620.

During the next processor cycle, each Virtual Processor will move on to the next stage in the instruction cycle. Since VP#1 just finished completing an instruction cycle it will start a new instruction cycle, beginning with the first stage, Fetch Instruction.

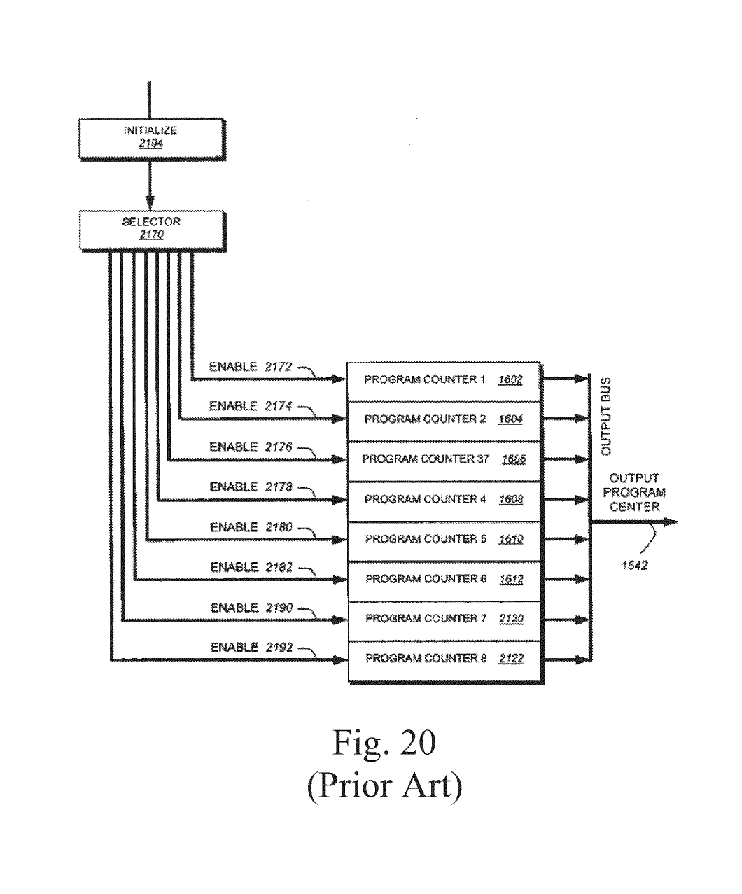

Note, in the architecture 2160, in conjunction with the additional virtual processors VP#7 and VP#8, the system control 1508 now includes VP#7 IR 2152 and VP#8 IR 2154. In addition, the registers for VP#7 (2132) and VP#8 (2134) have been added to the register block 1522. Moreover, with reference to FIG. 20, a Selector function 2110 is provided within the control 1508 to control the selection operation of each virtual processor VP#1-VP#8, thereby maintaining the orderly execution of tasks/threads, and optimizing advantages of the virtual processor architecture the has one output for each program counter and enables one of these every cycle. The enabled program counter will send its program counter value to the output bus, based upon the direction of the selector 2170 via each enable line 2172, 2174, 2176, 2178, 2180, 2182, 2190, 2192. This value will be received by Instruction Fetch unit 2140. In this configuration the Instruction Fetch unit 2140 need only support one input pathway, and each cycle the selector ensures that the respective program counter received by the Instruction Fetch unit 2140 is the correct one scheduled for that cycle. When the Selector 2170 receives an initialize input 2194, it resets to the beginning of its schedule. An example schedule would output Program Counter 1 during cycle 1, Program Counter 2 during cycle 2, etc. and Program Counter 8 during cycle 8, and starting the schedule over during cycle 9 to output Program Counter 1 during cycle 9, and so on . . . . A version of the selector function is applicable to any of the embodiments described herein in which a plurality of virtual processors are provided.

To complete the example, during hardware-cycle T=7 Virtual Processor #1 performs the Write Results stage, at T=8 Virtual Processor #1 (VP#1) performs the Increment PC stage, and will begin a new instruction cycle at T=9. In another example, the Virtual Processor may perform a memory operation during the Execute stage, which will require 4 cycles, from T=3 to T=6 in the previous example. This enables the architecture to use DRAM 2100 as a low-power, high-capacity data storage in place of a SRAM data cache by accommodating the higher latency of DRAM, thus improving power-efficiency. A feature of this architecture is that Virtual Processes pay no performance penalty for randomly accessing memory held within its assigned bank. This is quite a contrast to some high-speed architectures that use high-speed SRAM data cache, which is still typically not fast enough to retrieve data in a single cycle.

Each DRAM memory bank can be architected so as to use a comparable (or less) amount of power relative to the power consumption of the processor(s) it is locally serving. One method is to sufficiently share DRAM logic resources, such as those that select rows and read bit lines. During much of DRAM operations the logic is idling and merely asserting a previously calculated value. Using simple latches in these circuits would allow these assertions to continue and free-up the idling DRAM logic resources to serve other banks. Thus the DRAM logic resources could operate in a pipelined fashion to achieve better area efficiency and power efficiency.

Another method for reducing the power consumption of DRAM memory is to reduce the number of bits that are sensed during a memory operation. This can be done by decreasing the number of columns in a memory bank. This allows memory capacity to be traded for reduced power consumption, thus allowing the memory banks and processors to be balanced and use comparable power to each other.

The DRAM memory 2100 can be optimized for power efficiency by performing memory operations using chunks, also called “words”, that are as small as possible while still being sufficient for performance-critical sections of code. One such method might retrieve data in 32-bit chunks if registers on the CPU use 32-bits. Another method might optimize the memory chunks for use with instruction Fetch. For example, such a method might use 80-bit chunks in the case that instructions must often be fetched from data memory and the instructions are typically 80 bits or are a maximum of 80 bits.

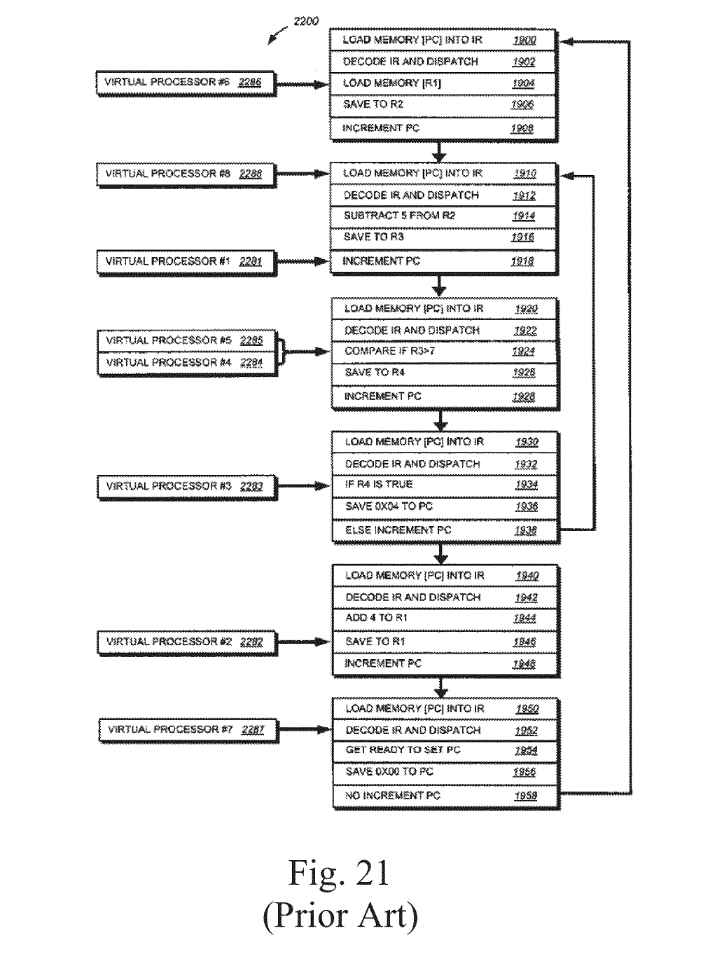

FIG. 21 is a block diagram 2200 showing an example state of the architecture 2160 in FIG. 19. Because DRAM memory access requires four cycles to complete, the Execute stage (1904, 1914, 1924, 1934, 1944, 1954) is allotted four cycles to complete, regardless of the instruction being executed. For this reason there will always be four virtual processors waiting in the Execute stage. In this example these four virtual processors are VP#3 (2283) executing a branch instruction 1934, VP#4 (2284) executing a comparison instruction 1924, VP#5 2285 executing a comparison instruction 1924, and VP#6 (2286) a memory instruction. The Fetch stage (1900, 1910, 1920, 1940, 1950) requires only one stage cycle to complete due to the use of a high-speed instruction store 2140. In the example, VP#8 (2288) is in the VP in the Fetch Instruction stage 1910. The Decode and Dispatch stage (1902, 1912, 1922, 1932, 1942, 1952) also requires just one cycle to complete, and in this example VP#7 (2287) is executing this stage 1952. The Write Result stage (1906, 1916, 1926, 1936, 1946, 1956) also requires only one cycle to complete, and in this example VP#2 (2282) is executing this stage 1946. The Increment PC stage (1908, 1918, 1928, 1938, 1948, 1958) also requires only one stage to complete, and in this example VP#1 (1981) is executing this stage 1918. This snapshot of a microprocessor executing 8 Virtual Processors (2281-2288) will be used as a starting point for a sequential analysis in the next figure.

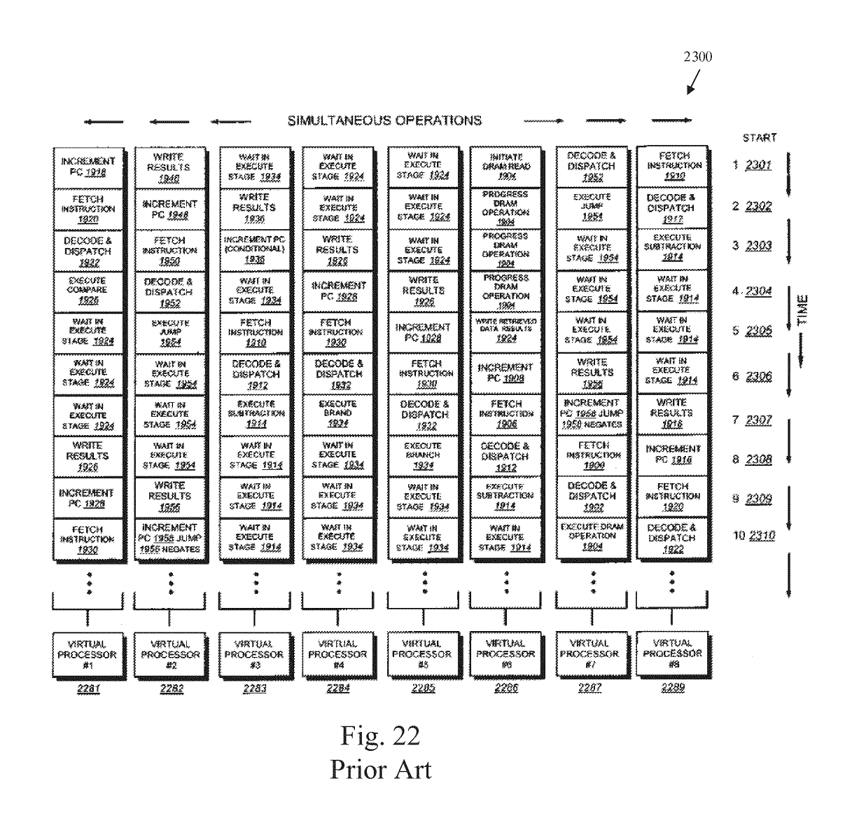

FIG. 22 is a block diagram 2300 illustrating 10 cycles of operation during which 8 Virtual Processors (2281-2288) execute the same program but starting at different points of execution. At any point in time (2301-2310) it can be seen that all Instruction Cycle stages are being performed by different Virtual Processors (2281-2288) at the same time. In addition, three of the Virtual Processors (2281-2288) are waiting in the execution stage, and, if the executing instruction is a memory operation, this process is waiting for the memory operation to complete. More specifically in the case of a memory READ instruction this process is waiting for the memory data to arrive from the DRAM memory banks This is the case for VP#8 (2288) at times T=4, T=5, and T=6 (2304, 2305, 2306).

When virtual processors are able to perform their memory operations using only local DRAM memory, the example architecture is able to operate in a real-time fashion because all of these instructions execute for a fixed duration.

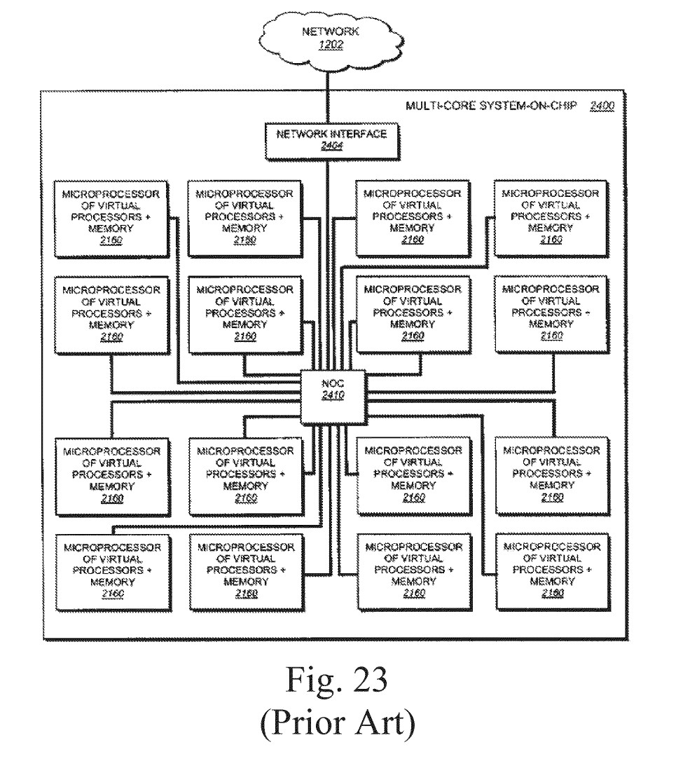

FIG. 23 is a block diagram of a multi-core system-on-chip 2400. Each core is a microprocessor implementing multiple virtual processors and multiple banks of DRAM memory 2160. The microprocessors interface with a network-on-chip (NOC) 2410 switch such as a crossbar switch. The architecture sacrifices total available bandwidth, if necessary, to reduce the power consumption of the network-on-chip such that it does not impact overall chip power consumption beyond a tolerable threshold. The network interface 2404 communicates with the microprocessors using the same protocol the microprocessors use to communicate with each other over the NOC 2410. If an IP core (licensable chip component) implements a desired network interface, an adapter circuit may be used to translate microprocessor communication to the on-chip interface of the network interface IP core.

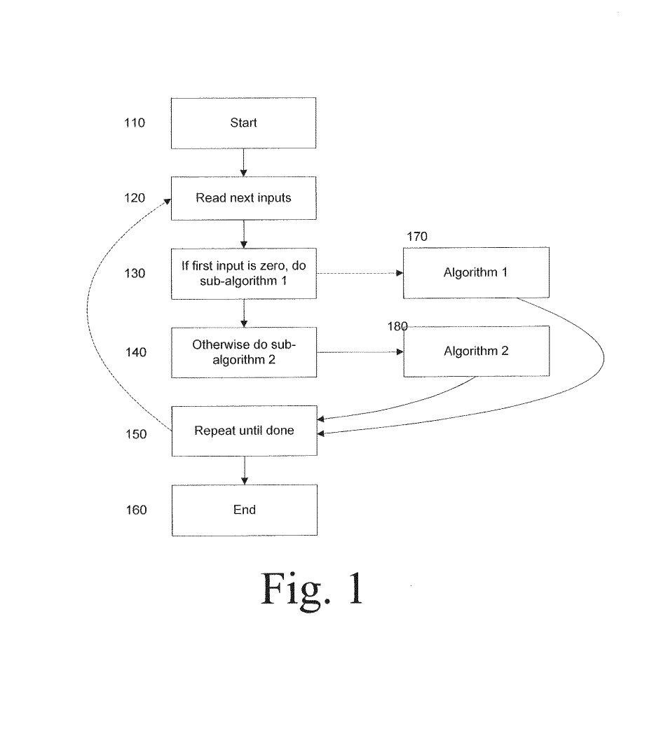

Referring to FIG. 1, an exemplary computer program that may be executed on the parallel computing architecture described above is shown. Execution of the program begins at step 110 and immediately proceeds to step 120. At step 120, the loop iteration begins by reading inputs for the current loop iteration. At step 130, the program determines whether the first input is zero and if so, performs sub-algorithm 1. The program then proceeds to perform “Algorithm 1” at step 170 or proceeds through step 140 to perform “Algorithm 2” at step 180. In both cases, once the algorithm completes (which may itself contain internal loops not shown in FIG. 1), execution proceeds next to step 150. A comparison is made internal to the step 150, so that if the comparison indicates that there is more work to do and the end has not come, then the loop restarts at step 120. If the comparison in step 150 determines that the end has come, then execution proceeds to completion at step 160.

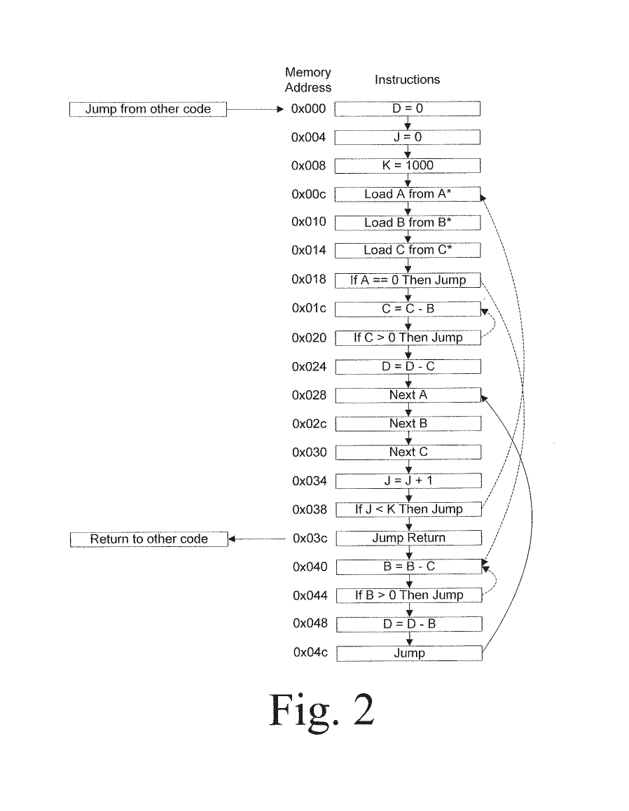

FIG. 2 shows the assembly code for the program shown in FIG. 1. The assembly code instructions are shown in the instructions column. The lay-out of the program in memory is also shown such that the address of an instruction in a box in the “Instructions” column appears in the program location indicated by the hexadecimal number (which are always preceded by “0x”) immediately to the left of said instruction, in the “Memory Address” column. Execution of the program starts at 0x0000 in this illustrative example, as indicated by the “Jump from other code” box. Execution ends at the instruction at address 0x044 as indicated by the arrow pointing from that instruction to the “Return to other code” box. Program flow typically follows the short arrows that connect a box with the box immediately below it in the Instructions column. The exceptions are Jump instructions and conditional jump instructions (e.g., if statements).

In the example of FIG. 2, a processing core will begin by executing at memory address 0x000 and proceed one-by-one to the next adjacent instruction below until the instruction “If A==0 Then Jump” at address 0x018 is encountered. Each instruction is executed a single cycle so that if the first instruction at 0x000 is executed in cycle #1 then 0x004 is executed in cycle #2, 0x008 is executed in cycle #3, and so on until the instruction at 0x018 is executed in cycle #7. During cycle #7 the input A, which was loaded in the 0x00c instruction “Load A from A*” is compared with zero, and if it is equal to zero, then execution proceeds so that the instruction at 0x040 is executed in cycle 8. In this example, the value previously loaded into A is equal to zero and so execution proceeds from 0x018 to 0x040, which is the beginning of “Algorithm 2” from step 180. Upon encountering instruction 0x040 in cycle 8, some simple arithmetic is performed in which the values originally loaded in instructions “Load B from B*” (0x010) and “Load C from C*” (0x014) are added and then stored into data location that previously stored the original B value, but will now contain the value B+C.

Execution then proceeds to the conditional branch instruction “If B>0 Then Jump” at 0x044. In this illustrative example, B and C are −4 and −8 and so the addition of them is equal to −12, so that the value currently stored in B is −12, which is not greater than zero, and therefore the conditional branch is said to have been “not taken” and execution proceeds from the 0x044 in cycle 9 to 0x048 in cycle 10. In cycle 10, the results in B are subtracted from D and then stored in the data location of D, replacing the old D value. In this way D serves as an aggregating value, which will combine the results of the loop of instructions 0x040 to 0x044 into D, and D will also persist through the larger loop from 0x00c to 0x04c. In cycle 11 the Jump instruction is executed at 0x04c, and then a execution progresses consecutively from 0x028 to 0x038 during cycles 12-16 respectively. In cycle #15 instruction “J=J+1” increments the value of J, which was initialized to zero in instruction 0x04 during cycle #2. This J value retains a count of which iteration in the larger loop is currently being executed. During cycle #16 the J value is compared against the K value, which was initialized in cycle #3 at instruction 0x08. And the loop will continue until J is greater than or equal to K. Once J is greater than or equal to K execution will proceed to 0x0c “Jump Return”, after which execution of the program will complete, as indicated by the arrow pointing to “Return to other code”. During the completion of the loop iteration code would proceed to the beginning of the loop during cycle #17, which starts loading new values for the fresh iteration starting by loading the new value for A in instruction 0x00c.

If the branch at address 0x018 is not taken then execution will proceed to instruction “C=C−B”, which begins “Algorithm 1” from step 170. Instruction 0x020 then conditionally branches to complete the loop internal to algorithm 1, or proceeds to instruction 0x024, which is followed by instruction 0x028. Thus address 0x028 follows after both algorithm 1 and algorithm 2, and leads to the comparison at address 0x038, which determines whether execution is complete as in step 150.

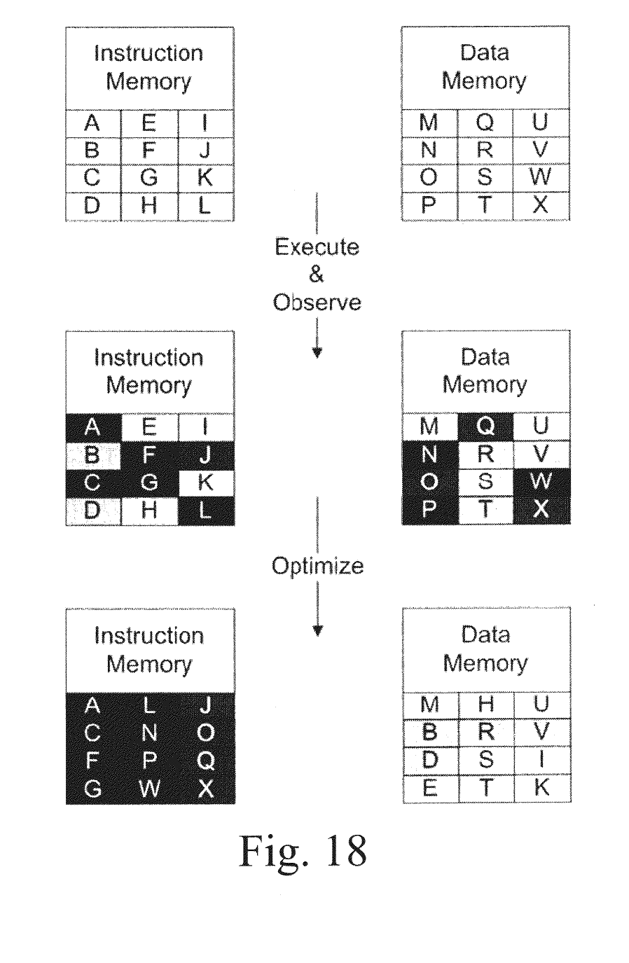

An example of the optimization technique for optimizing the assembly code layout of a computer program such as that shown in FIG. 2 is shown with reference to FIG. 18. In the top row of boxes, a program is shown having instructions A-X, arranged between instruction memory and data memory without regard for the frequency of execution of the instructions. The program is compiled and run to determine the frequency of execution of the instructions. The middle row shows the frequency of execution of the instructions. In the middle and bottom rows, darker fill colors in the boxes indicate instructions with more frequently observed execution. Some or all of these boxes having the darker fill color correspond to instructions from the inner loop of the program. The bottom row shows the program recompiled so that instructions that are executed most often are placed in the instruction memory, while those that are executed less often are preferably placed in data memory if they do not fit in the instruction memory. Thus, the bottom row shows the program arranged in memory such that instructions in boxes having the darker fill colors are in instruction memory, while the instructions that do not fit in the instruction memory are in data memory.

To optimize execution of the program as shown in FIG. 18, an optimizer receives a program to be optimized. Execution of the program in the native configuration is observed to determine which portions of code are most frequently executed. In another embodiment, the execution is observed to determine which portion of codes are most frequently requested and/or are waited on by a parallel code execution of another thread. The optimizer uses the observations of the execution of the native configuration when recompiling the code. The determined sections of code are augmented with other sections of code that are determined by the optimizer to be related with the determined sections. When the code is recompiled, the code is rearranged so that the determined and augmented sections of code will be placed into instruction memory, as shown in the bottom row of FIG. 18, while the remaining sections of code are placed in data memory. Thus, upon execution of the recompiled code, the most frequently executed pieces of code can now be retrieved from the instruction memory.

During the naive execution of the program, data on how the program execution proceeds is collected in order to determine which parts of the program are performance-critical. Whereas some prior art systems collect raw instruction counts, preferably, detailed information regarding the execution is collected in order to detect instruction clusters, instructions that typically execute very close in time with each other. Detection of instruction clusters allows software control of the instruction memory to reload the instruction memory at run-time, which can allow the instruction memory to perform in a manner similar to a cache in certain circumstances, but without the overhead of hardware implementation of a content-addressable memory of a cache.

To collect the detailed data, logging instructions are inserted into the program during a diagnostic run. In one alternative embodiment, because the logging instructions increase the size of the program, a supplementary instruction memory is included in the architecture which is deactivated during normal operation but activated during diagnostic operation. The supplementary instruction memory increases the size of the available instruction memory during diagnostic operation, thereby consuming additional power. However, the increase in available instruction memory allows for a more realistic simulation of the real world operation of the program. During normal execution of the program, the supplemental instruction memory is deactivated and therefore does not consume any power. Therefore, since diagnostic execution is rare compared to normal execution of the program, the increase in power consumption of the overall system due to the supplemental instruction memory is minimal.

The logging instructions inserted into the program cause log data to be saved for later processing. Three types of logging instructions that may be inserted into the program are provided. A first type of instruction marks that execution has passed through a certain point in the program. A second type of instruction is similar to the first type, but includes a mark as to what synchronization lock (e.g. Mutex) is being waited for, and at what time the waiting started. A third type of instruction is similar to the second type, but instead of marking the beginning of a lock-wait, it marks the release of a certain lock.

Preferably, the logging instructions are capable of executing quickly. The data storage holding the logged data should be fast and large enough to write large numbers of log entries. In one embodiment of the parallel processing architecture having many processing cores and local persistent storage, some of the local chips can be taken “offline” for diagnostic computation and dedicated for the sole purpose of logging data to their local persistent storage (e.g. flash chips). In this way, a computer chip with only 1 gbps of local persistent storage bandwidth in a capacity of 32 GB might gain 10 gbps of persistent storage bandwidth in a capacity of 320 GB by accessing chips local to it on the network fabric using the higher network fabric bandwidth available to local network messages.

Furthermore, the logging instruction is implemented similarly to a modified memory operation which writes to memory located off-chip but local in the network fabric. In a power efficient architecture, memory-write instructions are typically allowed one input register, one output register, one immediate operand, and write to one memory location. Although the immediate variable is typically an offset to the memory address that will be written to, and do not write to a register, the modified instruction uses the immediate operand as the data to be written, writes directly to the memory address pointed to by the input operand, and stores back to register a new memory address value which is an increment version of the previous memory address (e.g. 0x80 would be incremented to 0x84). In this way just one instruction is capable of writing a mark specific to the location of the instruction (designated by the immediate), read the address to be written to (which is off-chip and therefore the log data is sent off-chip, enabling dedication of increased resources to the storage of the log data), and increments the address so that when the instruction, or instructions like it, are encountered to log data in the future they will write data to the next memory location rather than overwriting the previous log data.

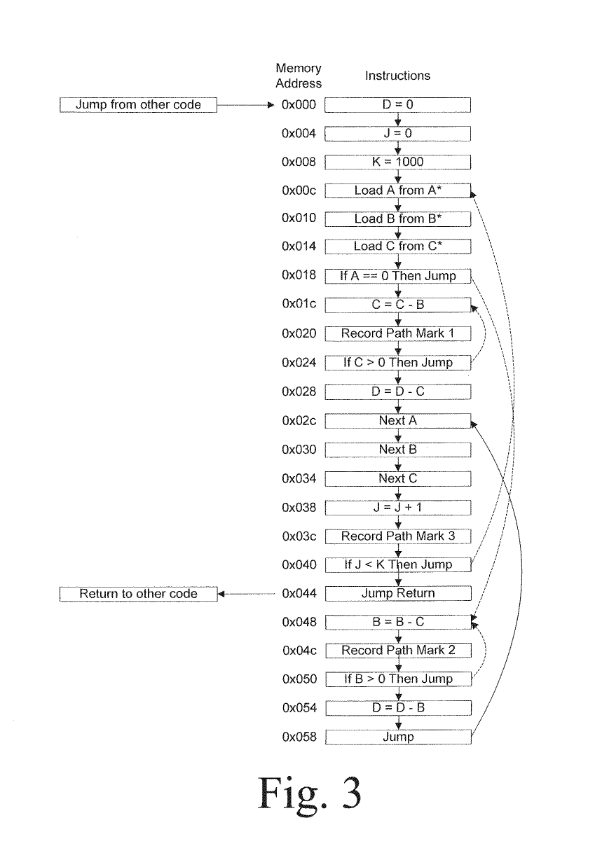

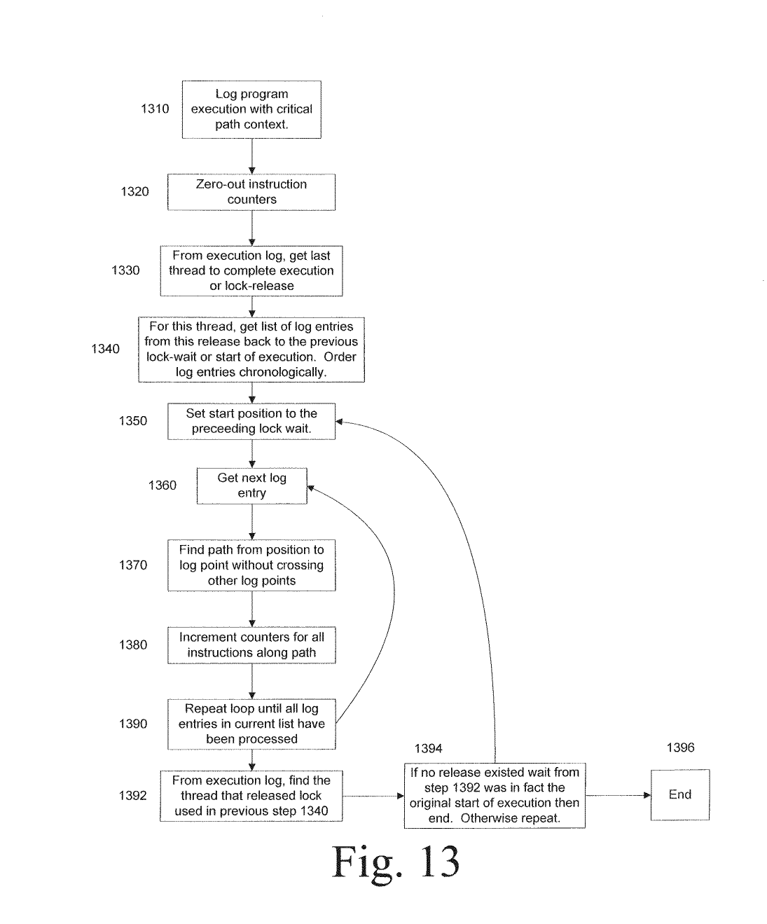

The first type of logging instruction is explained with reference to FIGS. 03-12. The second and third types of logging instructions are explained with reference to FIGS. 13-15.

Program with Single Thread

FIG. 3 illustrates three logging instructions inserted into a program at instruction addresses 0x020, 0x04c, and 0x03c, respectively. The three logging instructions have mark labels 1, 2, and 3, respectively. The logging instructions are inserted into a program such that the path of execution is unambiguous. That is, there is only one path through the program to access the particular logging instruction. This can be achieved by, for example, inserting logging instructions in path cycles that do not have logging instructions. Inserting a single logging instruction can potentially eliminate multiple such cycles, so multiple combinations of layouts between instruction memory and data memory can be tried, and these locations can be modified in future diagnostic runs in order to decrease the amount of logging data, while maintaining an unambiguous record of the execution.

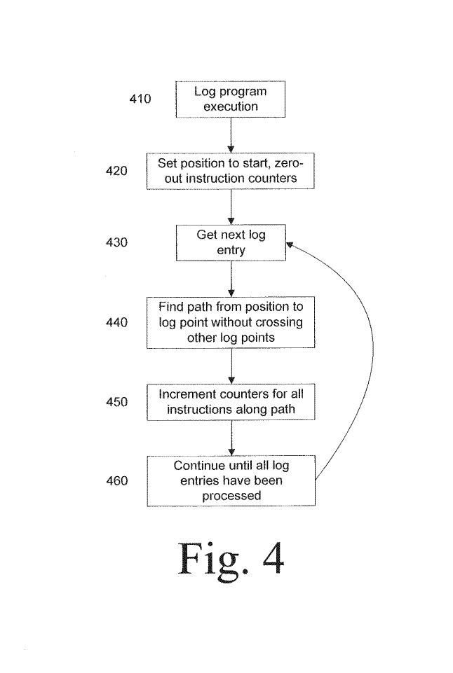

Referring to FIG. 4, the procedure for processing the log data is shown for the case that the instruction memory will not be changed after initialization and the best performance is delivered by decreasing the average completion time of instructions. The first step is to log the data during a diagnostic run (410). Next, the instruction counters are initialized to zero and the position of the simulated program counter is set to 0x000 (420). The log is then retrieved in step 430 and processed entry by entry (440) by incrementing the counts of all instructions along the path (450) which has unambiguously been logged. As shown in step 440, the path selected from the current position in the log point does not cross other log points. This process proceeds until all entries have been processed and the execution has been traced to completion (460).

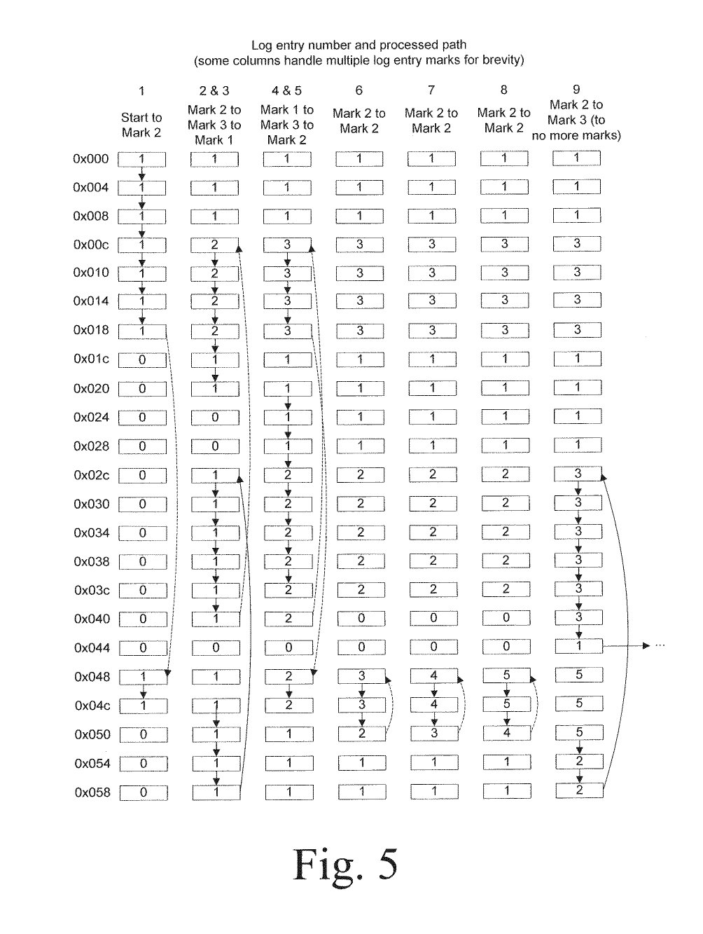

FIG. 5 shows an illustrative example for reconstructing the path of execution using the method of FIG. 4, from the log which was recorded during execution of the program shown in FIG. 3. In FIG. 5, the hexadecimal numbers preceded by “0x” on the left side of the figure represent the same instructions shown in FIG. 3. During execution, messages were logged where the message was one of “Mark 1”, “Mark 2”, or “Mark 3”, designating that the code reached position 0x020, 0x04c, or 0x03c respectively. Using these marks, which only log when the program is in three of the possible twenty three positions, a cycle-by-cycle path of execution can be reconstructed with the current position of the program counter known regardless of it being any of the twenty three possible instructions.

As shown by the column headings of FIG. 5, nine different marks were logged. The numbers heading each column indicate which log entries (1, 2&3, 4&5, 6, 7 . . . etc.) have their execution path shown in the corresponding column. The marks logged, in order from left to right, are Mark 2, 3, 1, 3, 2, 2, 2, 2, 3. The last mark, “Mark 3” occurs in the rightmost column designated by the “9” header which shows that it was the ninth logged entry. The path of execution is now reconstructed, retaining independent counts for each instruction during this process to record how frequently each instruction was executed. The 9 log entries are processed in order in seven separate steps, designated by the 7 columns. Note that though nine columns could have been used, the second and third columns of FIG. 5 (from the left) are shown with two log entries each (2&3 and 4&5 respectively) for brevity.

The process of tracing the execution path will now be explained with reference to FIG. 5. The first log entry is processed and the path is traced as far as possible using that log entry. The path of the first log entry leads up to and includes the first logged entry of “Mark 2”. Therefore the path is traced from the Start of execution at location 0x000 through the path through which execution could reach the position at which “Mark 2” is logged (0x04c) without passing through a different Mark logging instruction (i.e. through Mark 1 or Mark 3). This is shown by the leftmost column (column “1”), wherein the arrows point from 0x000 to 0x004, 0x0004 to 0x0008 . . . etc., until they reach 0x018 where they must jump (shown by the dashed arrow, indicating a conditional jump/branch) to 0x48. Otherwise the path would pass through the Mark 3 logging instruction at 0x3c shown in FIG. 3. The arrows then progress to the Mark 2 logging instruction of 0x04c. As shown in FIG. 5, all of the boxes (i.e., instructions) in the left column which are on the executed path shown by appearing at the start or end of an arrow have been set to a count of 1, indicating that they have been executed once, whereas all of the rest of the boxes remain at zero, indicating that these instructions have not yet been executed.

Referring again to FIG. 5, the second column headed by “2 & 3” shows the path of execution accounting for the next log entries being Mark 3, followed by Mark 1. As shown, the program proceeds from location 0x04c progressively to 0x58, where the program jumps (see jump instruction at 0x58 in FIG. 3) to 0x02c. Execution progresses from 0x02c until the location of Mark 3 is reached at location 0x3c. Having passed through Mark 3, the path is next traced to Mark 1. In tracing the program to Mark 1, the program proceeds from location 0x03c to location 0x040, where a conditional branch is encountered. If execution were to proceed to location 0x044 there would be no more log entries. However, since there is another log entry, Mark 1, the conditional branch to 0x00c must be taken, as shown in FIG. 3 by the dashed arrow starting at location 0x040. After the conditional branch, execution normally, one by one, until location 0x020, having the logging instruction for “Mark 1” is reached. The count of every box which has an arrow pointing to it in column 2 is incremented so as to keep a record of how many times each instruction has been executed. This count is cumulative so that some of the instructions show they have been executed twice, while others have only been executed once.

This tracing process is repeated for each of the additional columns shown in FIG. 5. The number of times each instruction is executed is counted while tracing the paths, until all columns have been traced. After all columns have been traced as described above, the numbers inside the boxes of the rightmost column show the total number of times each instruction was executed. In the example of FIG. 5, the instructions at locations 0x048, 0x04c and 0x050 were each executed five times, the most of any of the instructions in the program and each instruction in the program has been executed at least once.

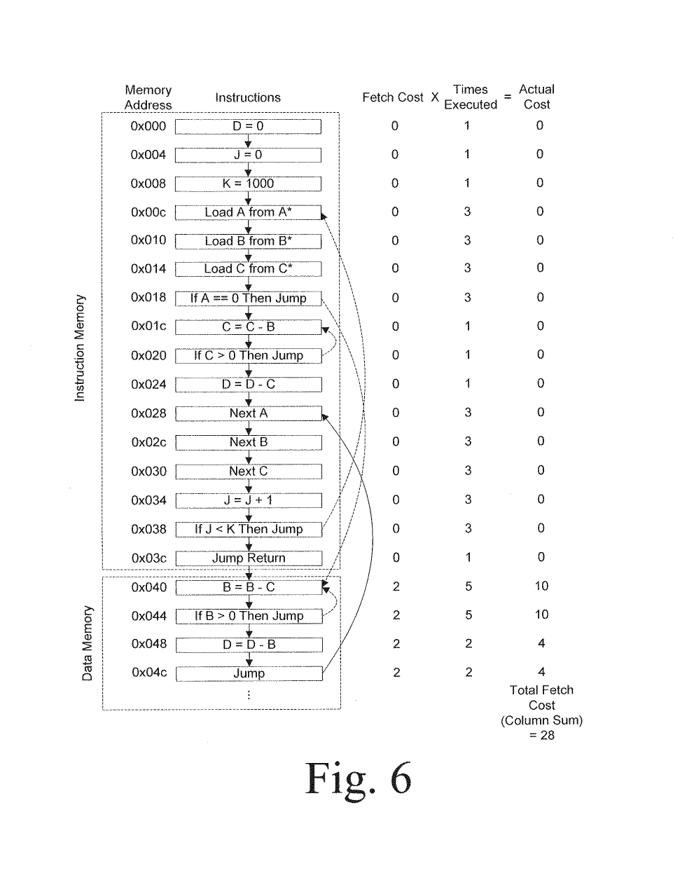

FIG. 6 shows one embodiment of the present system having 64 bytes of instruction memory. The instruction memory is able to hold sixteen four-byte instructions, shown as memory addresses 0x000 through 0x03c. However, in other embodiments, the size of the instruction memory, the size of each instruction and the number of instructions that may be stored by the instruction memory may each vary. Data memory is used to hold the overflow instructions that cannot be placed into the instruction memory. Dashed boxes between the instruction memory and data memory show the separation of the instruction memory and data memory boundaries. The instructions stored in the instruction and data memories of FIG. 6 correspond to the instructions from FIG. 2, thus the logging instructions and their counts in the “Times Fetched” column have been removed.

The values for the total number of executions of the instructions (with the logging instructions removed) from the right column of FIG. 5 are shown in the “Times Executed” column in FIG. 6. The cost of an instruction fetch for each of the respective memories is shown in the “Fetch Cost” column. Fetches from instruction memory are shown to have zero cost because there is no added cost for this type of fetch over a typical instruction execution. In contrast to fetches from instruction memory, instructions fetched from data memory have an additional cost of 2 cycles. In other embodiments, the fetch cost for fetches from the instruction memory and the data memory may be higher or lower than in the embodiment described with respect to FIG. 6. These costs are multiplied by the number of times the instructions stored in the data memory have been executed to determine an actual cost for execution of each instruction in FIG. 6. A total fetch cost of 28 cycles for the layout of FIG. 6 is calculated by summing the actual costs for each of the instructions of the program.

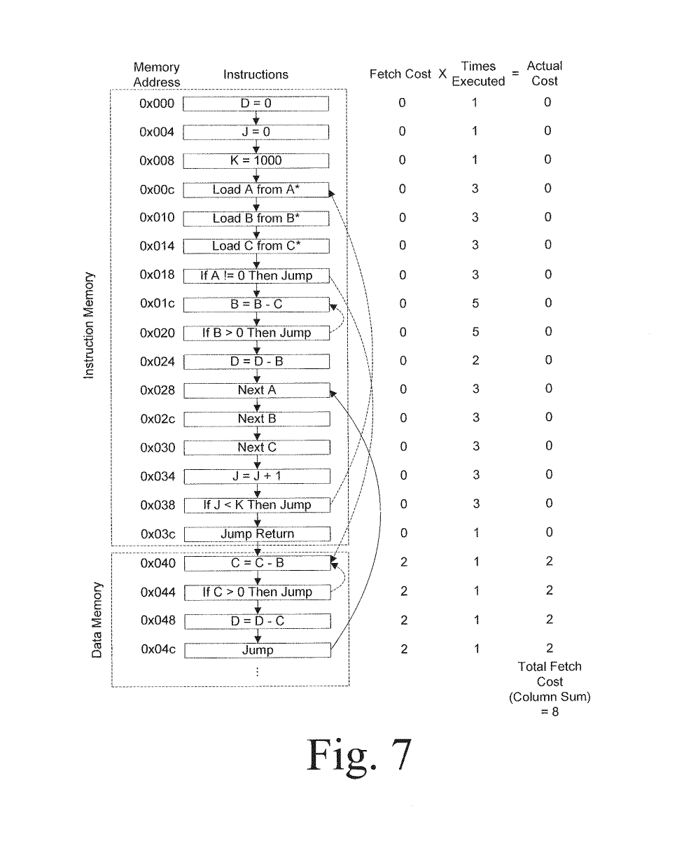

Referring to FIG. 7, the program of FIG. 2 is shown in a new code layout determined based on the execution of the program described with respect to FIGS. 5 and 6. In FIG. 7, instructions that were executed a relatively fewer number of times are moved to the data memory in order to move instructions which were executed a relatively higher number of times to the instruction memory. In order to make this shift, the direction of the branch at address 0x018 was changed to branch when not equal to zero instead of when equal to zero. This change in the branch allows us to swap code in memory addresses 0x01 c, 0x020, and 0x024, which were each only executed 1 time in the diagnostic run of FIG. 5 with code at memory addresses 0x040, 0x044, and 0x048, which was executed five, five, and two times, respectively. As a result, more frequently executed instructions have been moved from data memory to instruction memory, and instructions that were executed less frequently were moved to the data memory. The change reduces the total additional fetch cycle cost to 8, a reduction of 20 cycles in total from the example of FIG. 6. As a result of the change, the runtime of the system was decreased by 20 cycles with the new layout and the penalty suffered for having 64 bytes of instruction memory was cut by over 70% compared to the original layout of FIG. 6.

Program with Multiple Threads

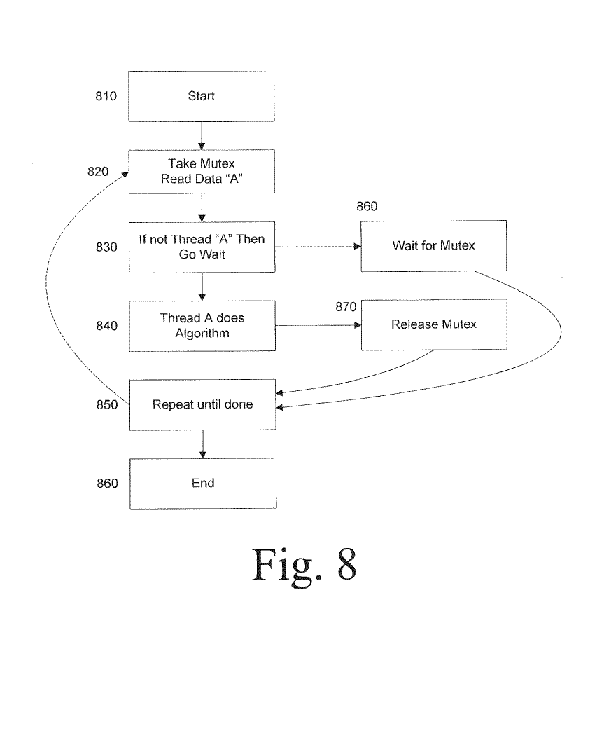

FIG. 8 shows a program having multiple threads executing on the same processor core in a barrel paradigm or the like. The program begins at 810 and proceeds to step 820 where the data “A” is read. The threads will initialize the lock so that threads will be prepared to wait when they arrive at 860. It does not matter if multiple threads attempt to lock the same mutex, as a locked mutex will simply stay in locked mode. Upon encountering step 830, all threads except thread “A” will proceed to step 860 and wait for the release of the mutex lock. Thread A then executes an algorithm (840) and subsequently releases the lock for which all other threads are waiting (870), after which all threads proceed to step 850 and repeat this process until they are finished executing (880).

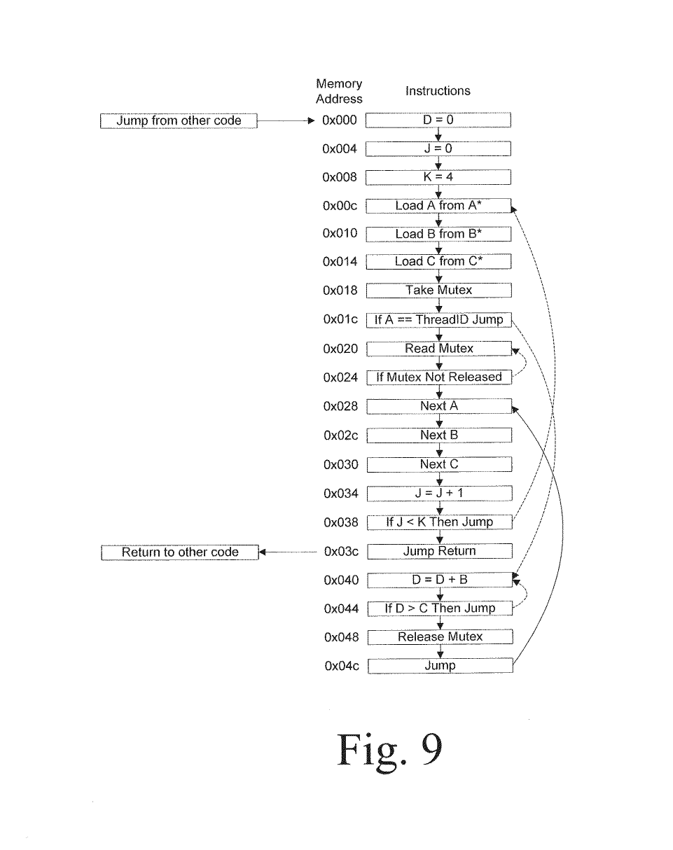

FIG. 9 shows the program assembly instructions and initial layout for the program shown in FIG. 8. The program includes twenty instructions arranged at memory addresses 0x000 to 0x04c. Similarly to the program of FIG. 2, there is a jump to the program from other code and a jump from the program to return to other code. Various jumps within the program are illustrated by the dashed and solid lines to the right of the instructions.

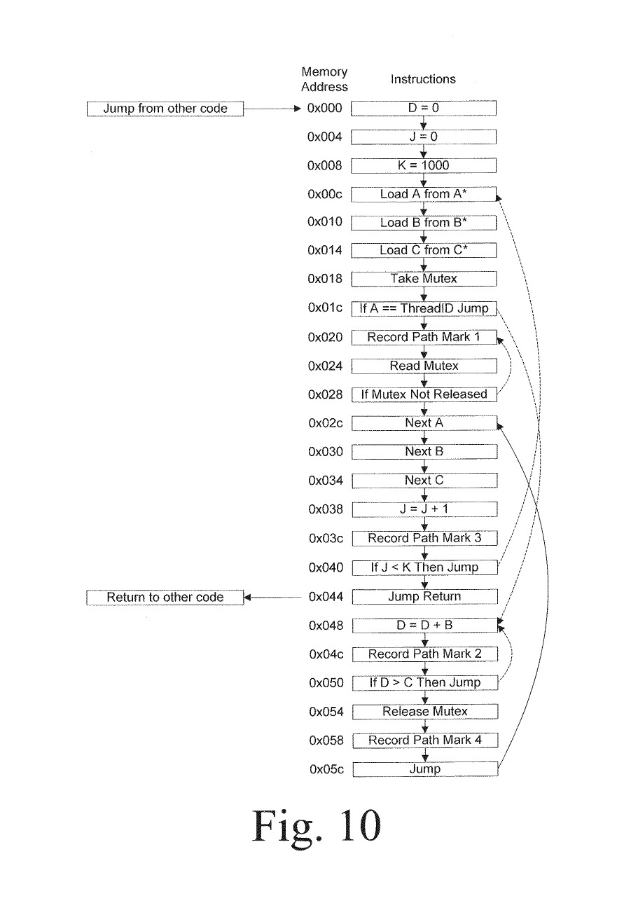

Referring to FIG. 10, the program with only the previously described first type of logging instruction is shown. The first type of logging instruction does not timestamp and does not indicate whether a mutex is being released or being waited for. Therefore, the previously used analysis and code relayout method is inadequate for improving performance in this new program. Note that although instructions 0x020 through 0x028 merely implement the wait-for-lock operation, a naive system would not know that it is unimportant how many times a waiting thread loops through the wait loop. Thus, the “Record Path Mark 1” is included in the loop, thereby increasing the number of log entries and log bandwidth that are required for amount of execution time.

The above logging code and more advanced logging methods of the second and third logging instruction type are preferably utilized to improve the result of the optimization run for a program having multiple threads. The above-described parallel architecture, having ability to execute instructions with single-cycle throughput and single-cycle latency costs, including instructions that are typically multi-cycle in modern architectures is well-suited to the optimization of this embodiment because the intrinsic determinism of the architecture allows relatively simple calculation of the effects of code layout rearrangement. For example, branches cannot be “mispredicted,” and there is no ambiguity as to how long memory operations will take, in contrast to the various types of L1, L2 and L3 cache misses of typical modern systems. Thus, whereas the effects of adding moving instructions in the program layout can have difficult-to-predict consequences in typical modern architectures, the parallel computing architecture described above has easy-to-predict execution times for instructions. Further, the additional overhead of instructions being placed in data versus instruction memory is also easily predictable.

In this embodiment, the data memory is 32-bits wide whereas the instruction words are 64-bits and the instruction memory is 64-bits in size. Therefore, fetching instructions from data memory requires an additional 2 cycles of 32-bit fetches before finally executing the instruction during a third cycle, that is a 2 cycle added penalty per instruction word is taken for executing the instruction from data memory.

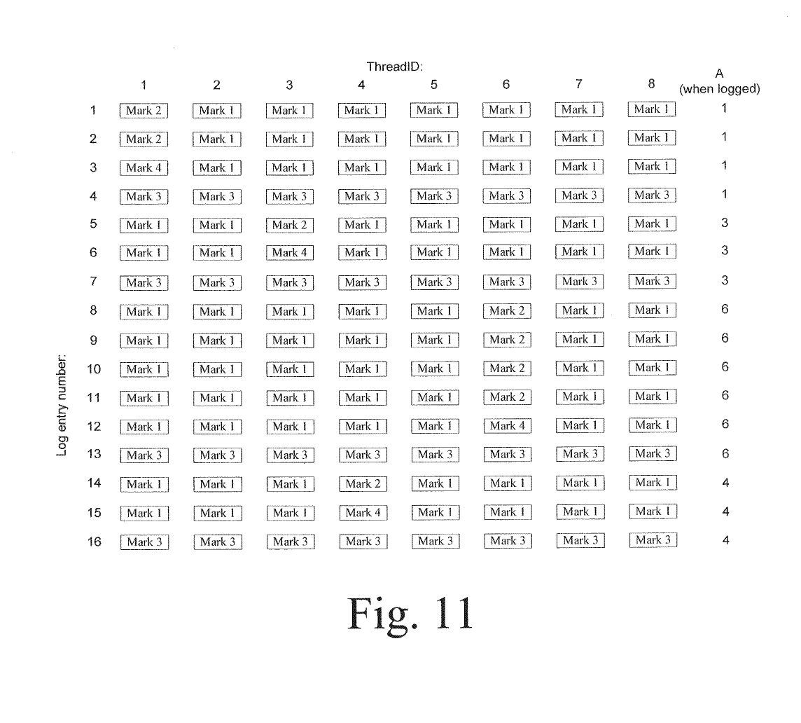

FIG. 11 illustrates eight different threads (columns 1-8), each executing on different virtual processors, logging their progress through time. In FIG. 11, each column corresponds to a different thread and each row corresponds to a log entry such that lower entries in a column were logged later than higher entries in the same column. The value of the variable “A” is also shown on the rightmost column to give an idea of what thread (or virtual processor as in FIG. 21) is performing useful work during the log entries on the same row. For example, thread 6 performed useful work when the log entries in row 11 were logged. Thread 6 is also shown as Virtual Processor #6 2286 in FIG. 21 and uses register hardware R1630 in FIG. 19.

Each of the eight threads in FIG. 11 logged sixteen different entries. However, it is possible for the threads to log different numbers of entries if, for example, a thread happened to finish and exit very quickly while the others continued to do work. The entries may be processed in the same way as described with respect to FIG. 5. However, this method is less effective for this embodiment.

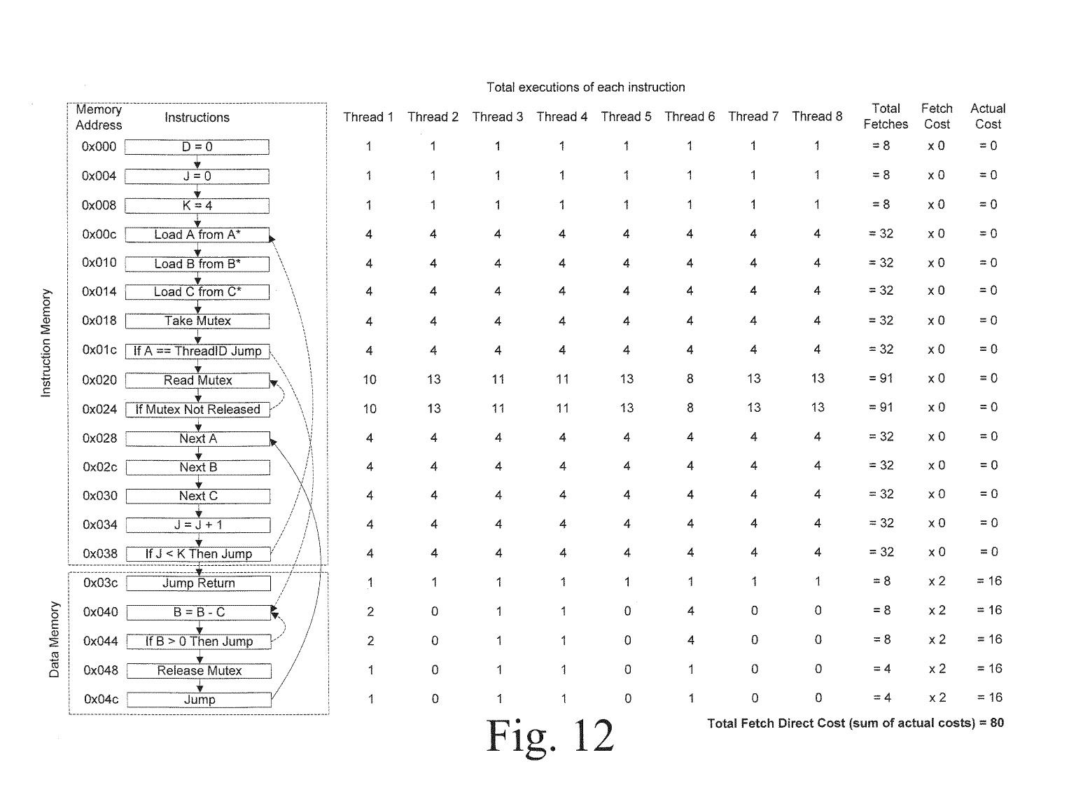

Referring to FIG. 12, each thread's log is separately processed using the method described with respect to FIG. 5 for calculating the total fetch cost (not shown). FIG. 12 corresponds to FIG. 6, but shows values for “Times Executed” for all eight threads instead of just one thread, and these values are summed across all threads. The initial code layout is shown to be relatively good quality by this metric, with a Total Fetch Cost of 80, since the instructions stored in data memory (memory addresses starting at 0x3c) are executed 8, 8, 4, and 4 times respectively and no instructions in the instruction memory (memory address 0x3c) execute fewer than eight times. Therefore, the current layout is considered optimal when only the first type of logging instructions are present in the program code. Since the configuration is considered optimal, no changes to the layout are suggested by the analysis.

FIG. 13 shows another flowchart illustrating steps for logging data for the program with multiple threads. In this embodiment, lock information is used in order to calculate the critical path of the recorded execution. The critical path is able to show which instructions, if executed faster (e.g., without an additional fetching cost) would cause the program to complete faster. Note that it is possible that rearranging code to decrease the execution time of the critical path can cause other paths to become critical. In that case, the new critical paths may have higher total execution times because optimizations for the critical path in the analyzed log lead to removal of previously existing optimizations for executions that were previously not on the critical path. This can potentially cause the critical path to move elsewhere. For example, the critical path may move to different threads executing on different virtual processors 2281-2288 and for those critical paths to be larger than the original critical path. For this reason, it is important to not only consider how the code layout changes will impact the thread executing the critical path, but also how the other threads will be affected.

The example of FIG. 13 is simplified for the purpose of illustration and does not directly consider the costs of the threads on the non-critical path, but this information is readily available in the log data and the indirect effects of the layout changes can be predicted. Therefore, multiple layout changes can be considered and the one most likely to reduce overall runtime can be selected for the next diagnostic test. The code layout can continue to be improved as additional diagnostic runs attempt to find ever more improved code layouts. Information from previous log analyses can be incorporated in the selection process of the next code layout for diagnostic test.

Still referring to FIG. 13, it is determined which thread executing on one of the virtual processors 1-8 2281-2288 is on the critical path for the chronologically latest execution times that have not yet been processed, and then which logging marks were recorded by that thread during the time that that thread held the critical path for that period. Waits are linked with Releases using their time stamps. It is quite likely that the lengths of the logs will be different for different threads. The latest (in time) Release logged mark that has not yet been processed is determined, and then the critical path is traced backward for that thread until the Wait-logged-mark that occurred most recently before the release. The critical path then jumps to the Release-logged-mark that occurred for the same lock and was released most recently after that wait was initiated. This new release-logged-mark will be from a different thread, and tracing proceeds again back in the same manner as above, until the start of execution is reached. Analysis is then performed as normal for all marks along the critical path, but marks that are logged by threads during times that those threads were not on the critical path are not counted for summing of instruction executions that occurred on the critical path (but they are considered in determining whether a new code layout is likely to be a true improvement or would reduce performance through moving and increasing the critical path in the new layout).

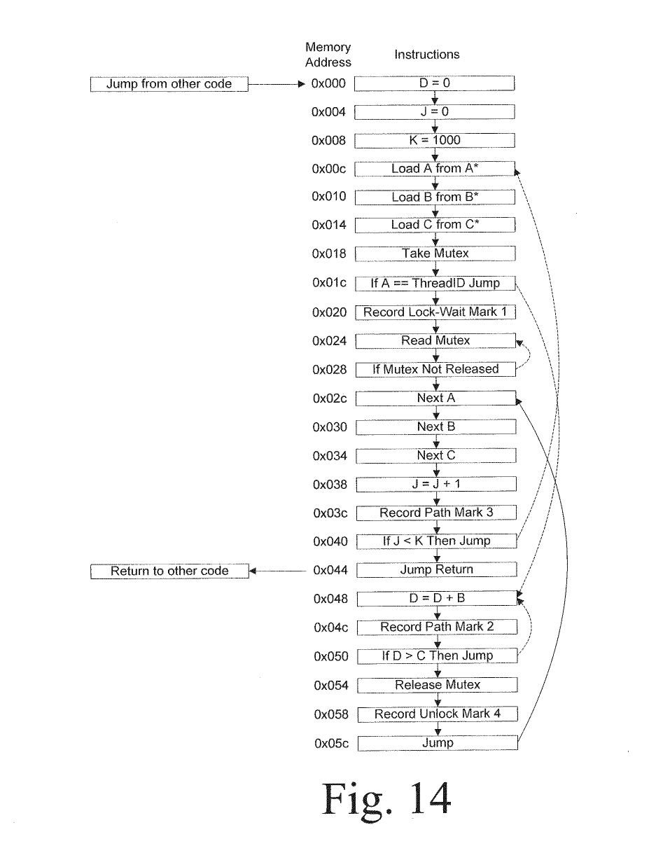

Referring to FIG. 14, logging instructions of type #1, #2 and #3 are introduced into the program. This includes the type #2 “Record Lock Wait” of the instruction at memory address 0x020, which has been identified as only needing to be executed once before the looping wait (also called “busy wait”) of the instructions at memory addresses 0x024 and 0x028. Therefore the logging bandwidth and capacity overhead requirements are reduced. The type #3 “Record Unlock” instruction at address 0x058 is also shown here.

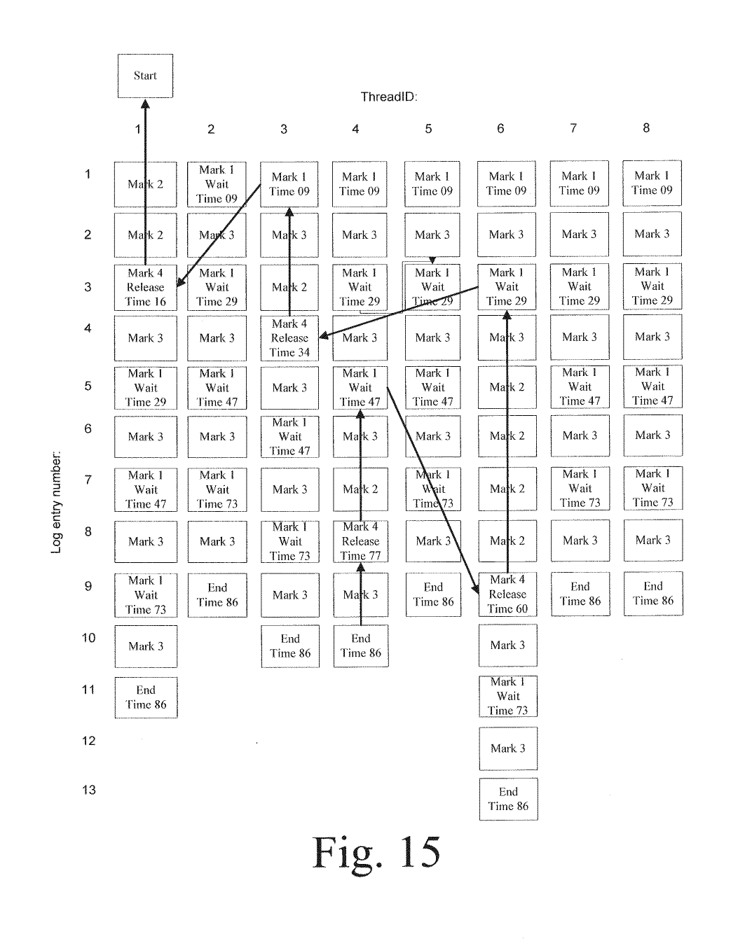

FIG. 15 shows the log entries for each thread in its respective column. For each thread, the log entries proceed from logged earlier to logged later from top to bottom. Note that there is no strict chronological relationship between log entries in different columns unless the times of the Wait and Release logging entries are consulted. For example, log entries in column A that appear above a Wait at time X will have occurred chronologically before log entries in column B appearing below a Release at a time greater than X in column B were logged. The arrows trace the critical path from the end back to start. Note that because all threads completed execution at the same time, the choice of which “End” log entry to start the critical path from is arbitrary. Here, thread 4 was selected as it is the thread that performed the most recent release.

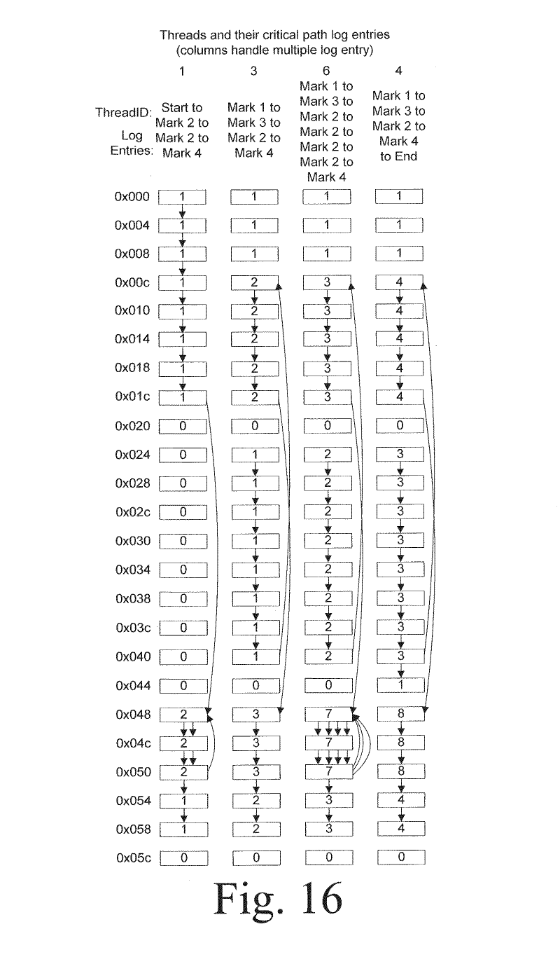

FIG. 16 illustrates how the marks are processed into instruction counts along the critical path. Four thread path segments were on the critical path as analyzed in FIG. 15. These four thread path segments correspond to the four columns of FIG. 16. The paths are traced for each of the separate critical pathways in each column using substantially the same method as in FIG. 5, with a key difference being that the path segments are not continuous but fragmented. For example the log entries traced in the left-most column, which were logged by thread #1 (as indicated by the column header) end the path at memory address 0x58, whereas the second column from the left shows the critical path for thread #3, starting at memory address 0x024 (not 0x58), where thread #3 became unlocked and first became on the critical path. The instruction counts for instructions occurring along the execution path for each critical path are incremented. The rightmost column shows the total number of times each instruction was executed along the critical path. Note that the instructions at memory addresses 0x05c and 0x020 never occurred on the critical path, which is an unintuitive finding since 0x5c is executed by the instruction that was on the critical path in just the previous cycle.

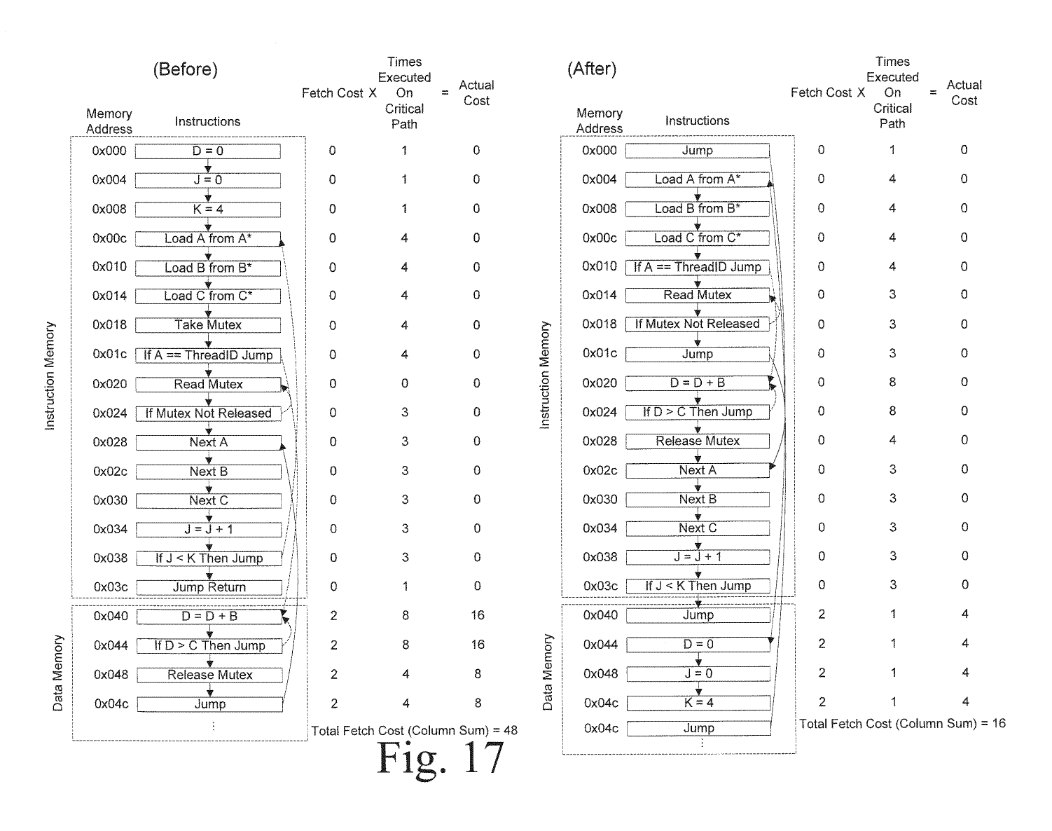

FIG. 17 shows an original code layout on the left that is similar to the layout of FIG. 6 and a reorganized code layout on the right that is similar to FIG. 7. The code layout on the left has an additional fetch cost of 48. This suggests that the execution End time of the code layout of FIG. 16 of 86 cycles would in fact be about 86 (normal number of cycles required)+48 (Fetch penalty)=134 cycles total when taking into account additional cost of fetches from non-instruction-memory (i.e. data memory 2100 of FIG. 19). This is the case even after the analysis conducted as shown with respect to FIG. 12 using only logging instructions of the first type.

In contrast to the original code layout, the reorganized code layout moves the initialization instructions, which only executed along the critical path once, to data memory. In addition, the return/exit instruction, which only executes at the end of the program is also moved to data memory. Jumps are inserted where necessary, e.g. at 0x000 to move the initialization code to data memory. These changes preferably do not modify the effective behavior of the program. As a result of these changes in the reorganized code layout, the fetch penalty is reduced to 16 cycles. The actual execution time is decreased from 134 cycles to about 102 cycles. The decrease from 48 fetch penalty cycles to 16 penalty cycles is a 66% reduction of cycles and results in a performance improvement of 30%. That is, 30% more work is done per second with the reorganized code layout than with the original code layout. This results in a decrease in run time of approximately 23% for a given workload.

In addition to the three types of logging instructions described, many packing algorithms exist for optimizing which code segments are inserted into instruction memory and which are removed. These packing algorithms can also be integrated into an algorithm that schedules transfers into and out of instruction memory during run time based on the current execution point in the program. Although this packing task is known to be NP-Complete (i.e. finding the optimal solution is intractable for programs of non-trivial size) many non-optimal solutions capable of finding improved layouts exist. Some of these solutions, such as the “First Fit Decreasing” binning algorithm, do not require great computational resources to compute and may be used in addition to the optimizing process described.

Note that any examples of the optimization system, such as the ones previously described, apply to this hardware architecture because the data memory 2100 and Fast Instruction Local Store 2140 of FIG. 19 are analogous to the data memory and instruction memory address regions that are described for optimization. Other examples also apply to the hardware architecture because of the single-cycle cost of most instructions in the hardware architecture, which makes the effects of changes in program layout easier to predict.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An automated method of optimizing execution of a program in a parallel processing environment, the program adapted to execute in data memory and instruction memory, the method comprising:
(a) receiving, at an optimizer, the program;
(b) compiling the program upon instruction by the optimizer, wherein the compiled program comprises logging instructions for determining the time during which execution of a first thread is waiting for execution of a second thread;
(c) executing the program upon instruction by the optimizer;
(d) the optimizer observing the execution of the program and, using information logged by the logging instructions for determining the time during which execution of a first thread is waiting for execution of a second thread, identifying a subset of instructions that are most frequently waited upon by other threads
(e) the optimizer identifying groups of instructions associated with the subset of instructions that are most frequently waited upon by other threads wherein the groups of instructions include the subset of instructions that are most frequently waited
upon by other threads and
(f) the optimizer recompiling the program and storing the identified groups of instructions including the subset of instructions that are most frequently waited upon by other threads in the instruction memory, and storing remaining portions of the program in the data memory,
wherein the instruction memory has a higher access rate and smaller capacity than the data memory, wherein subsequent execution of the program occurs using the recompiled program.

2. The method of claim 1, wherein step (d) further comprises identifying a subset of instructions that execute most often in threads that have outputs that other threads are waiting to receive, wherein the groups of instructions further include the subset of instructions that execute most often in the threads that have outputs that other threads are waiting to receive.

3. The method of claim 1, wherein the program comprises mutex locks.

4. The method of claim 3, wherein during execution of the program, the program waits for unlocking of a mutex lock.

5. The method of claim 3, wherein the releasing of a mutex lock by a thread results in the logging of information regarding the thread and information regarding the mutex lock that was released.

6. The method of claim 3, wherein acquiring a mutex lock by a thread results in the logging of information regarding the thread and information regarding the mutex that is acquired.

7. The method of claim 4, wherein the logging instructions for determining the time during which execution of a first thread is waiting for execution of a second thread log information responsive to waiting for unlocking of a mutex lock.

8. The method of claim 1, wherein a critical path is determined after execution of the program by analyzing data logged by the logging instructions, and wherein the execution of the program is subsequently optimized such that those sections of code executed by a thread that has acquired a lock that is on the critical path arc optimized in preference to code that is found to not be on the critical path.
